(19) United States
(12) Patent Application Publication
(10) Pub. No.: US 2018/0249856 A1
(43) Pub. Date: Sep. 6, 2018

(54) EGG POACHER

(71) Applicant: The Decor Corporation Pty Ltd, Scoresby (AU)

(72) Inventor: Jim Samartgis, Eltham (AU)

(21) Appl. No.: 15/972,067

(22) Filed: May 4, 2018

Related U.S. Application Data
(63) Continuation of application No. PCT/AU2016/051089, filed on Nov. 11, 2016.

(30) Foreign Application Priority Data
Nov. 13, 2015 (NZ) 714185

(51) Int. Cl. A47J 29/02; A47J 36/02

(52) U.S. Cl. CPC A47J 29/02; A47J 36/027

(57) ABSTRACT

An egg poacher for poaching one or more eggs in a microwave oven. The egg poacher includes a base member for holding water and an egg cup for holding a raw egg covered by water. The egg cup is removably supported by an upper portion of the base member so that the egg cup, in use, is partially submerged in the water in the base member. The egg cup is configured to be spaced from an adjacent wall of the base member so as to provide a gap between a side of the egg cup and the adjacent side of the base member so that, in use, water in the base, in combination with water covering the raw egg, creates a water shield that surrounds the raw egg.

### CROSS-REFERENCES TO RELATED APPLICATIONS

This application is a continuation application of International Patent Application No. PCT/AU2016/051089 entitled “EGG POACHER,” filed on Nov. 11, 2016, which claims priority to New Zealand Patent Application No. 714185, filed on Nov. 13, 2015, which are herein incorporated by reference in their entirety for all purposes.

### FIELD OF THE INVENTION

The present invention relates, in general terms, to an apparatus or utensil for use in the cooking/poaching of eggs, more particularly using microwave radiation in a microwave oven or microwave cooker of any known type.

### BACKGROUND OF THE INVENTION

Eggs are a popular food, for young and old alike. Whilst there exist a number of methods and means for the cooking of eggs, in a variety of ways, as for example fried and/or scrambled, poaching is one of the more popular forms of cooked egg. There are in existence a number of kitchen apparatus intended to be used for the poaching of one or more eggs for consumption. The majority of these rely on what can be referred to as conventional cooking apparatus, although there are in existence methods and means for the cooking of eggs using microwave radiation, in microwave ovens and the like equipment. However problems have been encountered in the past and with existing apparatus, whether conventional or microwave, for purposes of poaching an egg, in terms of ensuring consistent appearance, taste and texture of a poached egg.

The present invention seeks to overcome the problems and disadvantages associated with the known art by providing a method and apparatus, for use in a microwave oven, for the poaching of an egg, or a plurality of eggs, with the end result being an edible product of a consistent appearance, taste and texture. The method and apparatus in accordance with the present invention lends itself to ready repetition, to achieve consistency of result.

Conventional microwave ovens are kitchen appliances that heat and cook food by exposing the food to electromagnetic radiation in what is referred to as the microwave spectrum. Such exposure to electromagnetic radiation induces polar molecules in the food to rotate and produce thermal energy in a process known as dielectric heating. To be more specific, the electromagnetic wave/radiation excites water molecules in food, causing them to vibrate rapidly and heat the adjacent food. In that regard it should be understood that, in essence, microwave ovens produce energy, not heat. Microwaves do not cook any food from the inside out, but rather from the edge inwards. Microwave ovens have been found to heat foods quickly and efficiently because excitation is fairly uniform in, for example, the outer 25 to 38 millimetres of a homogenous or high water content food item. This results in food being more evenly heated throughout, when compared with other more conventional cooking techniques.

When cooking, as for example poaching, an egg or eggs in a microwave oven, the microwave radiation in effect targets the fatty egg yolk. This, in one scenario, can mean that there will be a tendency for the yolk to be over-cooked, while with the same cooking time the egg white may remain runny, in effect not properly cooked or undercooked. Indeed experience has shown that, if the cooking time is sufficiently long so as to have the egg white properly cooked, then in all probability the yolk will be overcooked, in fact hard to an unacceptable degree.

In another scenario eggs can be microwaved in a bain-marie style apparatus where an egg cup sits over a bath of water. The water in this case is radiated to be heated and turns to steam. This cooks the egg by steaming the egg in the egg cup, which presents similar problems to those described above in terms of overcooking the yolk and generally resulting in a cooked egg with a rubbery texture.

### BRIEF SUMMARY OF THE INVENTION

The present invention seeks to overcome the problems as described above associated with the prior art by providing a method and apparatus which will consistently produce the “perfect” poached egg, meaning one wherein both the yolk and egg white are properly cooked—being neither hard, rubbery nor runny (in terms of the egg white)—in a consistent and repetitive manner. Such a desirable result is achieved with an apparatus wherein there exists a barrier of water between the source of microwave radiation and the egg or eggs. Such barrier acts to “protect” the egg or eggs from the microwave radiation/energy. In essence the water making up the barrier is heated by the input microwave radiation, with the result being that it is the thus heated water which acts to cook the egg or eggs. It is this which allows the user to produce, consistently, an egg or eggs cooked to that user's requirements.

The invention provides an egg poacher for poaching one or more eggs in a microwave oven, the egg poacher including: a base member for holding water; an egg cup for holding a raw egg covered by water, the egg cup being removably supported by an upper portion of the base member so that the egg cup, in use, is partially submerged in the water in the base member, wherein the egg cup is configured to be spaced from an adjacent wall of the base member so as to provide a gap between a side of the egg cup and the adjacent side of the base member so that, in use, water in the base, in combination with water covering the raw egg, creates a water shield that surrounds the raw egg.

In and embodiment the gap is measured at a height of the egg cup that is approximate to the height of a raw egg in the egg cup, when supported by the upper portion of the base member. The gap may be 3 mm or greater, 4 mm or greater, 5 mm or greater, or 6 mm or greater, or 7 mm or greater, or 8 mm or greater.

In an embodiment the base member is constructed from a microwave transmissible material that is transparent to microwave radiation. The egg poacher may include a lid wherein the lid is constructed from a microwave transmissible material that is transparent to microwave radiation.

In an embodiment an upper support member supports the egg cup from an upper portion of the base member, the upper support member being a removable tray overlying the base member. The upper support member may be a tray that is constructed from a microwave transmissible material that is transparent to microwave radiation.

The invention also provides an egg poacher for the poaching of one or more eggs in a microwave oven, the egg poacher including: a base member for holding water; a tray which is adapted to be removably associated with the base member, the tray having at least one aperture extending therethrough; one or more cups for eggs, each cup adapted to be removably located in one of an aperture provided in the tray; and a lid, adapted in use to overlay the base and associated tray, the lid being of a shape such as to provide a gap between an upper surface of the tray and a lower surface of said lid, the tray spacing the egg cup from an adjacent side of the base member so as to provide a minimum gap between a side of the egg cup and the adjacent side of the base member, wherein the minimum gap extends around the entire horizontal periphery of the egg cup and is measured at a height of the egg cup that is approximate to the height of a raw egg placed in the egg cup with water on top, to thereby entirely shield the raw egg with water.

In an embodiment the egg cup is provided with insignia indicating a level to which the egg cup is recommended to be filled with water after the raw egg is placed in the egg cup. The base member may be provided with insignia indicating the level to which the base member is recommended to be filled with water.

In an embodiment the base member includes a bottom and a peripheral sidewall extending upwardly therefrom, the peripheral sidewall terminating, at the upper end thereof, in a peripheral lip depending outwardly and downwardly therefrom. The free end of said peripheral lip may include a flange extending therefrom and substantially normally/laterally thereof.

In an embodiment the tray includes a plurality of further smaller apertures extending therethrough, to allow for egress of steam. The lid may include a plurality of apertures therethrough, to allow for egress of steam.

In an embodiment the egg cup is in the form of a cup-like member including a base or main body portion, closed at one end, and a substantially conical portion extending from the upper end of said base or main body portion. The base or main body portion may have a height of between 25 mm and 40 mm, and preferably between 30 mm and 40 mm, which also corresponds to the recommended depth of the raw egg/water mixture.

The invention also provides a method of poaching an egg including: filling a base member with water; locating a raw egg in an egg cup that is removably supported by an upper portion of the base member so that the egg cup submerges in the water in the base member, wherein the egg cup is configured to be spaced from an adjacent side of the base member so as to provide a minimum gap between a side of the egg cup and an adjacent side of the base member, wherein the minimum gap extends around the horizontal periphery of the egg cup and is measured at a height of the egg cup that is approximate to the height of a raw egg in the egg cup, and at the gap, surrounding the egg cup with water; placing water in the egg cup on top of the egg; and radiating the base, egg cup and egg/water with microwaves in a microwave oven.

The method may include overlaying a lid over the base and egg cups.

In an embodiment described herein there is an apparatus for the cooking, preferably as by poaching, of one or more eggs in a microwave oven, said apparatus including: a base member for holding water; a tray which is adapted to be removably associated with said base member, said tray having at least one aperture extending therethrough, said aperture being preferably circular in profile; one or more containers for eggs, each container adapted to be removably located in one of said at least one aperture provided in said tray; and a lid, adapted in use to overlay said base and associated tray, said lid being of a shape such as to provide a gap between an upper surface of said tray and a lower surface of said lid, the arrangement being such as to provide a gap between a side of the or each said container and an adjacent side of said base member, wherein at least said base member and said one or more containers for eggs are constructed from a microwave transmissible material which is transparent to microwave radiation.

### BRIEF DESCRIPTION OF THE DRAWINGS

In order that the invention may be more clearly understood and put into practical effect reference will now be made to preferred embodiments of an apparatus in accordance with the present invention. The ensuing description is given by way of non-limitative example only and is with reference to the accompanying drawings, wherein:

FIG. 1 is an exploded perspective view, taken from above, of an especially preferred embodiment of an apparatus in accordance with the present invention;

FIG. 2 is a top view of the apparatus of FIG. 1;

FIG. 3 is a sectional view of the apparatus, taken along the line 3-3 of FIG. 2;

FIG. 4 is a top view of a base of the apparatus of FIG. 1;

FIG. 5 is an underneath view of the base of the apparatus of FIG. 1;

FIG. 6 is a top view of a tray of the apparatus of FIG. 1;

FIG. 7 is an underneath view of the tray of the apparatus of FIG. 1;

FIG. 8 is a top view of a lid of the apparatus of FIG. 1;

FIG. 9 is an underneath view of the lid of FIG. 8;

FIG. 10 and FIG. 11 are, respectively, front top perspective views and rear bottom perspective views of a container of an apparatus in accordance with the invention;

FIG. 12 is a cross-sectional view showing the interaction between the base, the tray and the lid; and

FIG. 13 is a cross-sectional view of the apparatus of FIG. 3, showing water added to the base and the container.

### DETAILED DESCRIPTION OF THE INVENTION

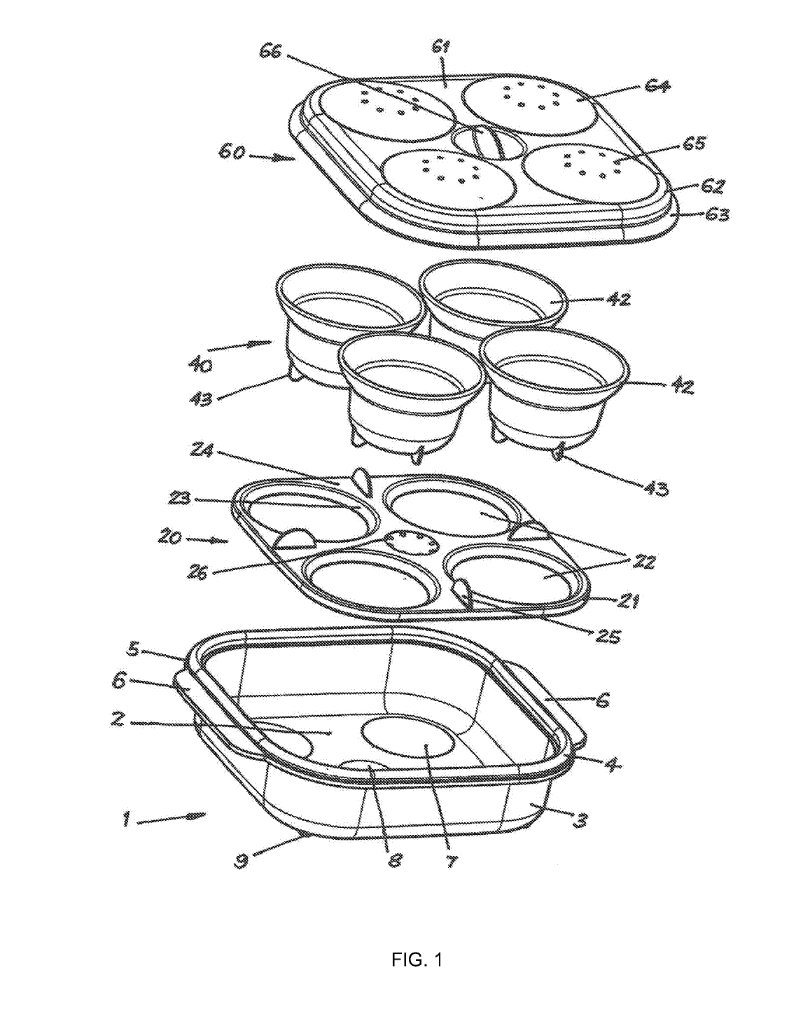

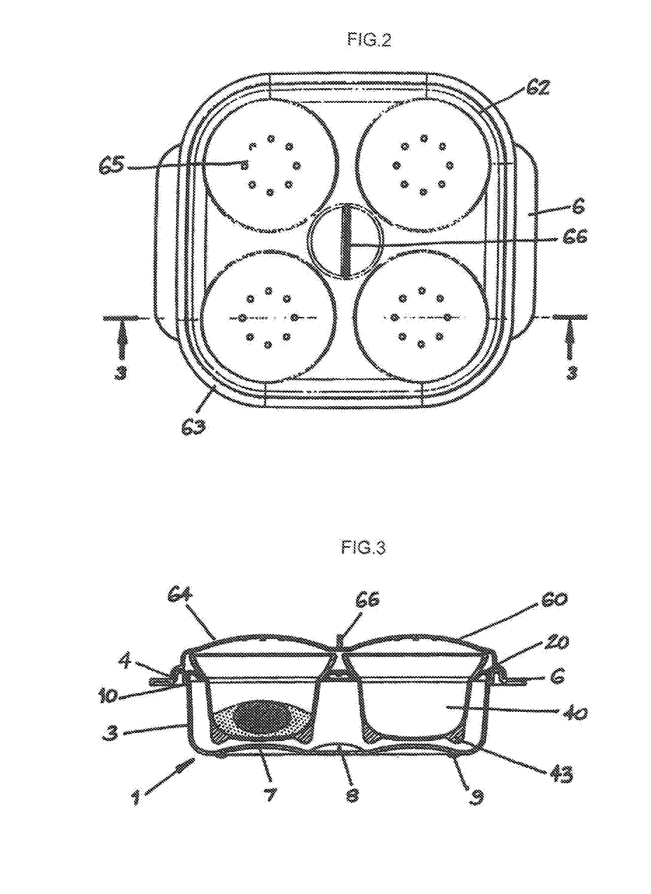

As shown in the drawings, and with particular regard to FIG. 1, an apparatus for use in the cooking/poaching of eggs in a microwave oven in accordance with the invention includes, a base 1, an upper support member in the form of a tray or cradle 20 which, in use, co-operates with, as by overlaying, the base 1, at least one container and, in the preferred embodiment shown four containers 40 for receiving eggs to be cooked/poached, those containers 40 being adapted in use to co-operate with the tray 20 (in a manner to be described hereinafter), and a lid 60. It is noted that throughout the description the term used to describe the component that holds the egg is interchangeably referred to as an “egg cup 40” or a “container 40”.

Preferably these components will all be constructed from a material that is transparent to microwave radiation, as for example, a suitable plastics material. However, it will be understood that not all of the components need to be made from a material that is transparent to microwave radiation. For example, only the base 1 and the lid 60, noting that a lid is an optional component, may be transparent to microwave radiation.

The egg poacher is configured so that in use the egg cups 40 are partially submerged in water contained in the base 1. In addition, water is poured into the egg cup 40 on top of the raw egg. The water contained in the base, and the water on top of the egg, creates a water shield that surrounds the raw egg and acts to reduce the amount of cooking caused by microwave radiation by absorbing a portion of the microwave radiation. In shielding the egg the water also increases in temperature, and it is substantially the hot water that cooks the raw egg, rather than the microwave radiation produced by the microwave oven. By cooking the egg through conduction from the surrounding water (i.e. from the outside of the egg inwards) the egg can be properly poached. In contrast, standard microwave cooking heats the entire mass of the food item at the same time, and when that food item is an egg the result is in an overcooked yolk.

The base 1, of an integral construction and preferably formed from a plastics material, includes a bottom 2 and an upwardly-extending peripheral or circumferential sidewall 3. In the especially preferred embodiment shown the base 1 is of a substantially square shape, when viewed in plan. It should be understood, however, that the actual shape of the base 1, when viewed in plan, and indeed the material of construction, are not of the essence of the invention.

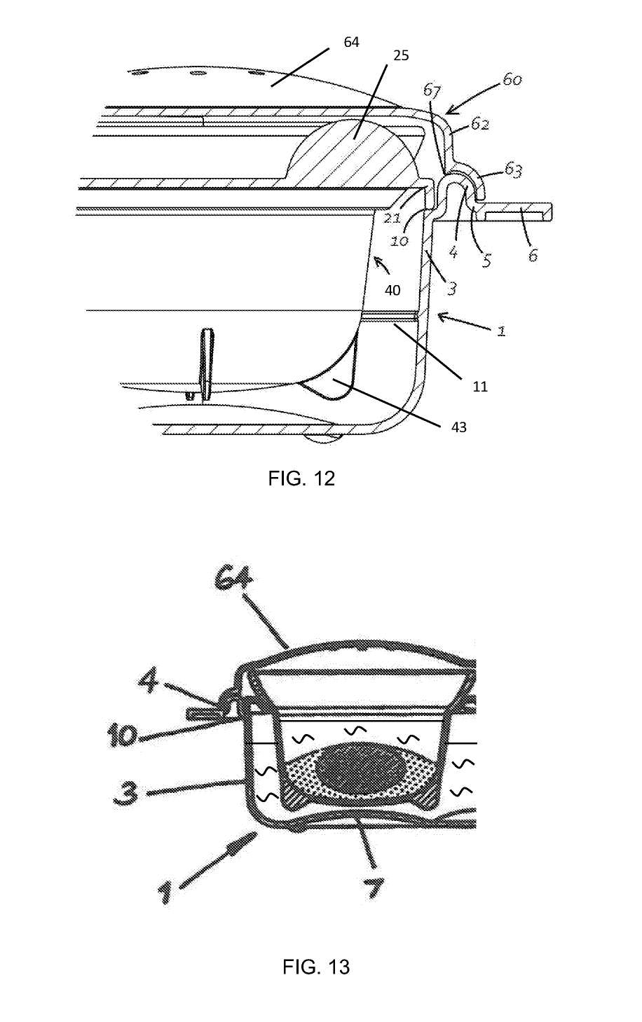

Referring to FIGS. 1 and 12, the peripheral or circumferential sidewall 3 terminates, at the upper end thereof which is spaced from the bottom 2 of the base 1, in a peripheral lip 4 which extends outwardly and downwardly from the upper end or edge of sidewall 3. The free end of the lip 4 has a flange or the like 5 extending substantially laterally therefrom and around the entire periphery/circumference of the base member 1. The flange 5 includes, as shown, at least one pair of opposed handle means 6. The flange 5 may act as a seating means for the lid 60. The opposed handle means 6 assist in safe and convenient removal of a hot or heated egg poacher from the microwave oven.

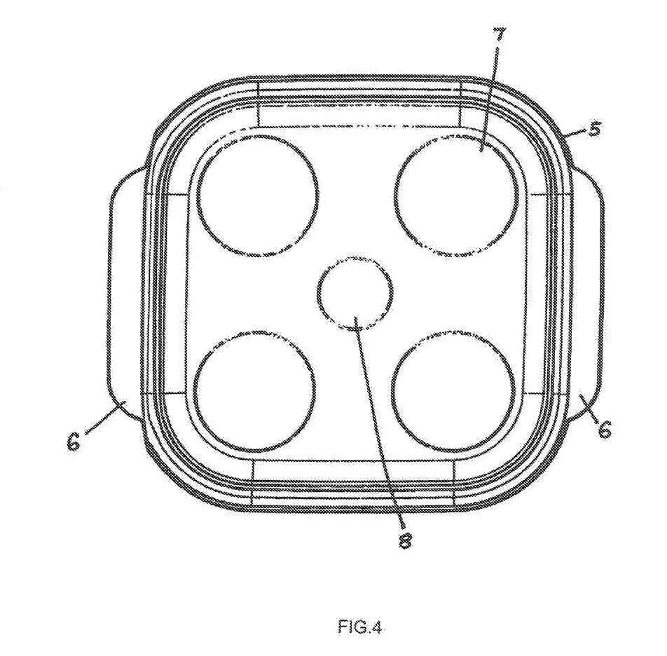

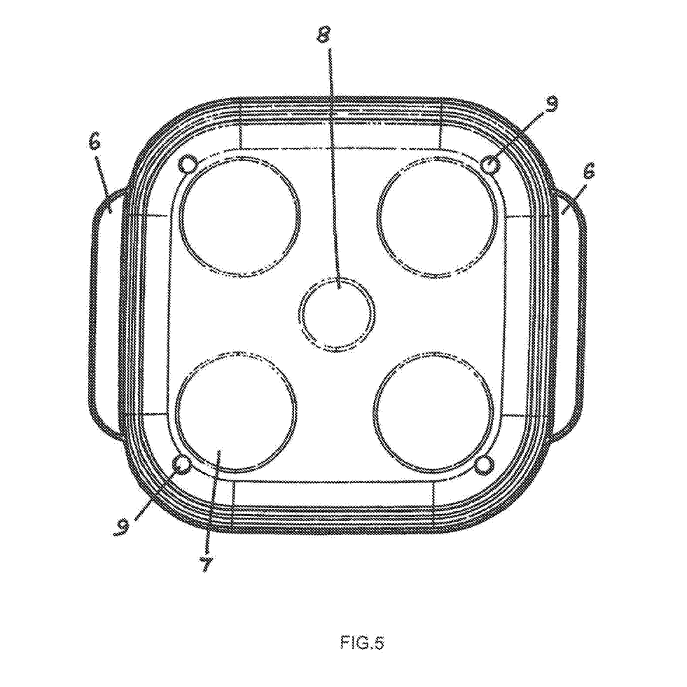

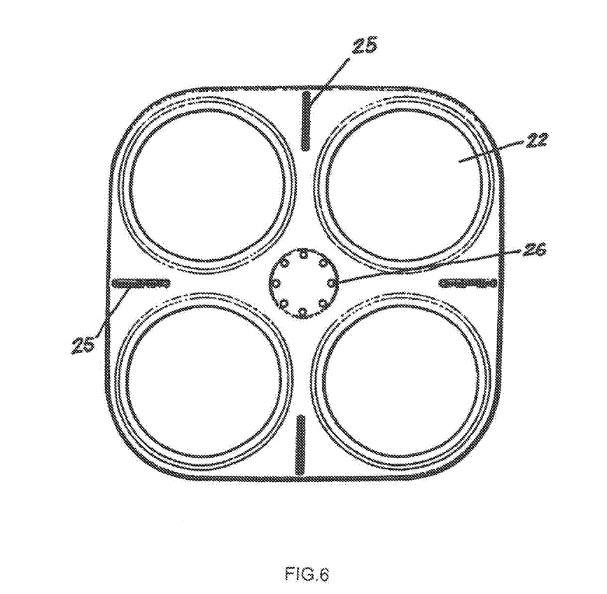

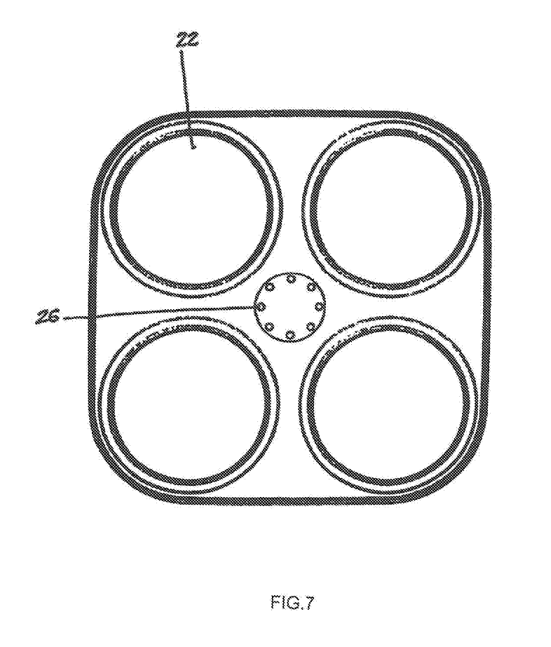

Referring to FIGS. 3 and 4, the base 1 includes, in the bottom 2 thereof, opposed pairs of raised dome-shaped sections 7, one located at or in the vicinity of each corner of the base 1, as well as a further dome-shaped raised section 8 located substantially centrally of the bottom 2. The base 1 further includes, preferably located at or in the vicinity of each corner of the bottom 2 thereof, downwardly-extending leg members, shown as projections 9, for separating or spacing the base 1 from a surface that it is placed on. For example, when the egg poacher is placed in a microwave oven, the projections 9 space the base 1 from the surface of the rotating plate of the microwave oven. The base member 1 has insignia, such as the words “FILL LEVEL” or a fill line 11, indicating the level to which the base member 1 is recommended to be filled with water in order to achieve the best cooked result by poaching. The fill line may be achieved by applying a differentiating surface treatment to a portion of the base member 1, for example, the intersection line of a rough surface against a smooth surface.

As perhaps best shown in FIG. 12, the peripheral sidewall 3 of the base 1 includes, at or in the vicinity of its uppermost end thereof, a step or indent, shown as step 10, which functions as a seat for the tray or cradle, shown as tray 20. More particularly, the step 10 is at or in the vicinity of the intersection of the lip 4 and the sidewall 3.

The tray 20 is of a substantially complementary shape to the base 1 when viewed in plan, and is adapted or intended, in use, to overlay and fit within the base 1. To that end the tray 20 includes a downwardly-extending peripheral lip 21, of a complementary shape but preferably of a shorter length to the lip 4 of base 1. In use the tray 20 sits within the base 1, with the lowermost free end of the lip 21 being in engagement with the indent 10 of the base 1 (see FIGS. 3 and 12). The tray 20, in the preferred embodiment shown, includes four spaced-apart apertures 22 extending therethrough, with each of the apertures 22 having a peripheral chamfer 23 depending downwardly from the top surface 24 of the tray 20.

The tray 20 further includes, extending upwardly from the top surface 24 thereof, one or more protrusions 25 which constitute means allowing for handling of the tray 20 as and when required, as for example when placing the tray 20 in the base 1 or when removing the tray 20 from that base 1. The tray 20 further includes, preferably located substantially centrally thereof, a plurality of smaller apertures 26, which allow for the egress from the base 1 of steam generated therein by microwave energy.

The container(s) 40 may be of any suitable size and/or shape. However, preferably the containers 40 are dimensioned such that, when located within the apertures 22 of the tray 20 and the tray 20 is disposed on the base 1, they are not in contact with the bottom 2 of the base 1. In other words the containers 40 are suspended above the bottom 2 of the base 1. In the especially preferred embodiment shown the or each container 40 may take the form of a cup-like member, including a base or main body portion, shown as base portion 41, which is closed at one end, and a conical portion 42 extending from the upper end of the base portion 41. The closed end 45 of the base portion 41 is preferably of an inverted dome-like shape. The base portion 41 has a height of between 25 mm and 40 mm, and preferably between 30 mm and 40 mm, and more preferably about 35 mm. The height of the base portion corresponds to the recommended depth of the raw egg/water mixture. In other words, the transition 44 between the base portion 41 and the conical portion 42 acts as a filling guide. The container 40 is provided with insignia, such as the words “FILL LEVEL”, indicating the level to which the egg cup is recommended to be filled with water after the raw egg is placed in the egg cup (i.e. to the transition between the base portion 41 and the conical portion 42). The volume of the container 40, up to the fill line/transition 44, is between 80 mL and 105 mL, preferably between 90 mL and 100 mL, and more preferably about 95 mL. The internal diameter of the main body 41 of the container 40 is between about 60 mm and 65 mm. The size of the main body 41 of the container 40 ensures that when an egg is cracked into the container 40 there is enough space for water to be added on top of the egg to form a water shield. In other words, the container 40 is sized to allow formation of a water shield above the raw egg.

As shown in FIGS. 1 and 3 the base portion of the container includes, at spaced-apart intervals around the periphery/circumference thereof, opposed pairs of legs or support means, shown as downwardly-extending shaped protrusions 43, allowing for the container 40 to be located on a surface, for example a breakfast bar or the like, without rocking or tilting. A user will generally place the container 40 on a flat surface to facilitate location therein of an egg that is to be cooked/poached. The fact that the base portion 41 is of an inverted dome-shape serves to ensure that, when an egg is located therein, the yoke is positioned centrally, ensuring even and consistent cooking. The conically shaped upper portion 42 of the container 40, as well as the inverted dome-shaped base portion 41, assist in removal of a cooked egg from the container 40. The chamfers 23 in the tray 20 assist in locating the containers 40 into the apertures 22. When a user places the container 40 into an aperture 22 in the tray 20 the conical portion 42 contacts and rests against the chamfer 23 of the aperture 22, thereby preventing the container 40 from falling through the aperture 22. The chamfers 23 also help to form a seal with the conical portion 42 on the containers 40.

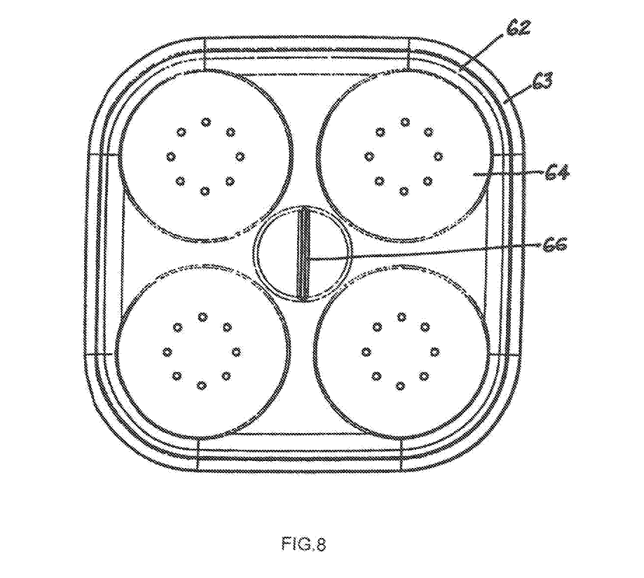

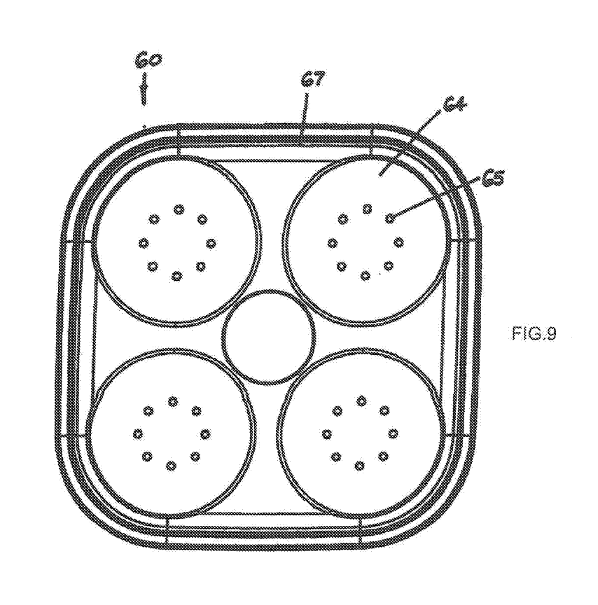

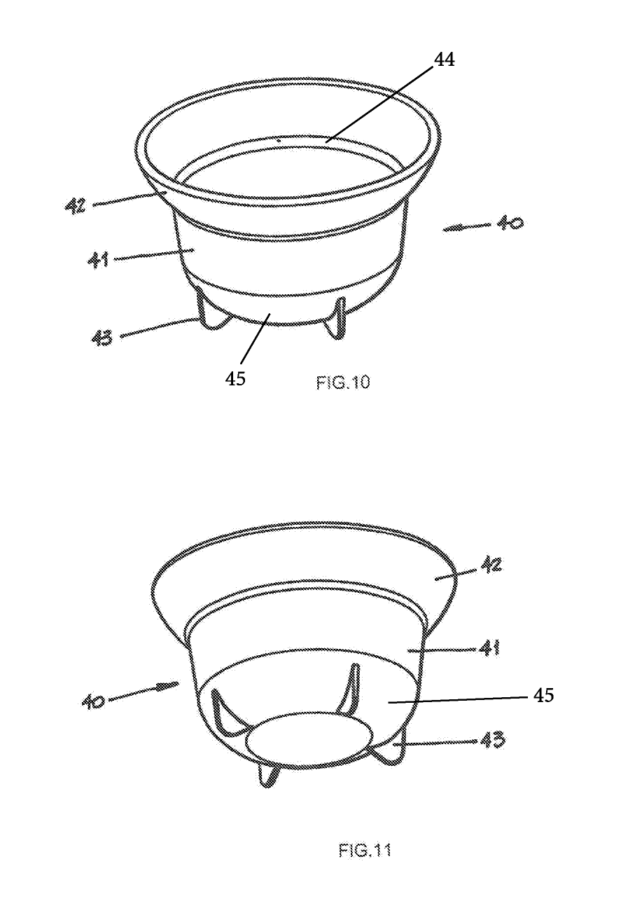

The lid 60, when viewed in plan view of FIG. 8, is of an integral construction and of a complementary shape to both the base 1 and the tray 20 and is adapted, in use, to overlay both. In the preferred embodiment illustrated (see FIG. 1) the lid 60 includes a top portion 61, having a stepped peripheral lip extending downwardly therefrom, the peripheral lip including stepped sections 62 and 63, with the arrangement being such that the lower section 63 co-operates with and is in an overlying relationship with the top portion of the base 1 at rim 4, resting on the handles 6 of base 1.

The lid 60, in like manner to base 1, includes four spaced-apart raised sections, shown as dome-shaped sections 64, each of a substantially circular shape when viewed in plan. Each of these dome-shaped sections 64 preferably includes a plurality of small apertures 65 extending therethrough. These small apertures 65 function to allow steam generated to escape, helping to ensure consistency and repeatability of cooking the eggs housed within the containers 40. The lid 60 further includes at least one gripping means or handle 66, preferably disposed substantially centrally thereof.

As best shown, for example, in FIG. 12, the lid 60 in an especially preferred embodiment will include, extending downwardly from the surface of that lid 60, a peripheral wall generally designated 67. Such wall 67 acts, in use, to prevent unwanted egress of condensed steam/water from the overall apparatus. In other words, the peripheral wall 67 of the lid 60 seals against the lip 4 of the base 1. In that regard it should be understood that, during cooking steam will be generated from the water in the base 1, and the container(s) 40, and will travel upwardly. Whilst the small apertures 65 in the lid 60 will allow for the passage therethrough of steam, the enlarged surface area prescribed by the lid 60 will give rise to or allow for condensation thereon. The dome-shaped sections 64 on lid will allow the condensate to move in a direction towards the junction of lid and base. The wall 67 ensures that all such condensate is directed back onto the tray 40 and/or containers 20 and/or base 1, preventing unwanted egress from the overall apparatus. Such is important in terms of cleanliness and safety. In addition, this helps to retain heat in the apparatus.

The method and apparatus in accordance with the present invention, which give rise to the improved result—a properly or perfectly poached egg every time—operate by transfer of heat through conduction, rather than through direct action of microwave energy.

With the subject apparatus, the method of cooking involves firstly filling the base 1 with water (either hot or cold) to the prescribed level, as indicated by the fill level insignia 11. Preferably, boiling water is placed in the base 1 to accelerate cooking time in the microwave. A raw egg is cracked into the container 40 for cooking, and a small amount of water (again, preferably boiling water) is also placed in each container 40 up to the height indicated by the fill level insignia. Generally the egg and water are added to the container 40 while on a flat working surface (as described above). The water placed in each container 40 rests above the eggs and acts to shield the egg from microwave radiation (during microwave cooking). The tray 20 is then placed onto the base 1, and the containers 40 (with the eggs and covering water) are located in the apertures 22 of the tray 20.

It should be understood that, in use, the container(s) 40 are suspended in or from the tray 20, and are protected by the water barrier from direct microwave energy. In this position the containers 40 are spaced from the peripheral wall 3 of the base 1 such that at least a working part of the containers 40 are surrounded by water, such that in practical terms the eggs are not heated directly by microwave radiation (as shown in FIG. 13). Rather, the radiation heats the water in the base 1 and the water in each container 40, and it is the heated water that does the cooking. In other words, there is sufficient water surrounding the containers 40, and on top of the egg, to shield the eggs from direct microwave energy or radiation. In that regard experimentation and experience has shown that microwaves can only effectively penetrate water to a limited extent or depth. The larger the gap between any two surface of the egg container and the base 1, and therefore the larger the amount of water occupying the gap, the greater the amount of microwave radiation will be reduced in power. In particular, as most of the radiation will be entering the egg poacher through the sides and top of the apparatus, the better results with the present egg poacher is to have a sufficient amount of water surrounding the egg (including surrounding the container 40) to provide a water barrier that will shield the egg from sufficient radiation to ensure the outside white of the egg is cooked first with the yoke being cooked mostly as a result of the heat conducting from the egg white and adjacently placed water.

The base 1, tray 20 and containers 40 of the present apparatus are shaped and sized so as, in use, to provide such a water barrier or shield for the contents of the containers 40 themselves. One reference point to determine whether there is sufficient water coverage/shielding of the egg can be measured when the egg container 40 is positioned in the base (i.e. supported by an upper portion/tray of the base), and partially submerged in the water in the base 1. It is desirable that the water level of the water in the base 1 is higher than the uppermost portion of the raw egg sitting in the container 40. Preferably, the water in the base is as high as the water level in the container 40. This means the water in the base 1, in combination with the water on top of the raw egg, encapsulate or surround the raw egg, thereby shielding the egg from the microwave radiation. This is shown in FIG. 13,

If the water level in the base 1 was lower than the upper surface of the raw egg, there is a risk that the raw egg, sitting touching the sides of the container 40 (underneath the water in the container) would be heated by radiation penetrating through the side wall of the base 1, through an air gap, and through the wall of the container 40 directly to the egg. In this case the egg would not enjoy the benefit of being shielded by water surrounding the exterior of the container 40.

Accordingly, a gap is required between between a side of the container 40 and an adjacent side wall 3 of the base 1 so that water is able to occupy that gap and shield the egg in the container. The gap would be measured at a point in line with approximately the average height, or top, of the egg sitting in the container. The gap is measured as a straight horizontal line along that point to the adjacent side wall 3 of the base 1.

It is estimated that a gap size of 3 mm or greater would produce a water wall that would provide adequate shielding of microwave radiation to cook the egg from the outside in. More preferably a gap size of 4 mm or greater, 5 mm or greater, 6 mm or greater, or 7 mm or greater would increase the absorbance of radiation. Larger gaps of 8 mm to 10 mm would also be suitable, as would gaps between 10 mm and 15 mm.

Once the eggs have been cooked the containers 40 are each removed so that the eggs can be served. As shown in FIGS. 3 and 13, a section of the conical portion 42 sits above the tray 20 to enable a user to grasp the container 40 for easy removal. The conical shape of the upper portion 42 of the container 40 assists in the user readily draining off excess water, to check and monitor cooking progress. In addition, as the containers 40 are individually removable they can be removed and drained one at a time.

The apertures 26 in the tray 20, and the apertures 65 in lid 60, allow steam to escape from the overall apparatus. More particularly excess steam can readily exit the apparatus, rather than being retained therein. This acts to ensure “correct” cooking of eggs within the apparatus.

With the present apparatus and method, application of microwave energy results in heating of the water barrier or shield, with heat energy then being transferred to the eggs located in the containers by conduction, convection and/or radiation. As a consequence the eggs are cooked/poached from the outside to the inside. This means that the egg white will be heated/cooked firstly, then the yolk. The degree of hardness required for the yolk—which will vary from person to person—is capable of being varied by appropriately adjusting the cooking and resting time.

Finally it is to be understood that the aforegoing description refers merely to preferred embodiments of the present invention and that variations and modifications will be possible thereto without departing from the spirit and scope of the invention, the ambit of which is to be determined from the following claims.

It is to be understood that, if any prior art publication is referred to herein, such reference does not constitute an admission that the publication forms a part of the common general knowledge in the art, in Australia or any other country.

In the claims which follow and in the preceding description of the iptioninvention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. An egg poacher for poaching one or more eggs in a microwave oven, the egg poacher including:
a base member for holding water;
an egg cup for holding a raw egg covered by water, the egg cup being removably supported by an upper portion of the base member so that the egg cup, in use, is partially submerged in the water in the base member, wherein the egg cup is configured to be spaced from an adjacent wall of the base member so as to provide a gap between a side of the egg cup and the adjacent side of the base member so that, in use, water in the base, in combination with water covering the raw egg, creates a water shield that surrounds the raw egg.

2. The egg poacher as claimed in claim 1, wherein the gap is measured at a height of the egg cup that is approximate to the height of a raw egg in the egg cup, when supported by the upper portion of the base member.

3. The egg poacher as claimed in claim 1, wherein the gap is 3 mm or greater.

4. The egg poacher as claimed in claim 3, wherein the minimum gap is 4 mm or greater, 5 mm or greater, or 6 mm or greater, or 7 mm or greater, or 8 mm or greater.

5. The egg poacher as claimed in claim 1, wherein the base member is constructed from a microwave transmissible material that is transparent to microwave radiation.

6. The egg poacher as claimed in claim 1, comprising a lid wherein the lid is constructed from a microwave transmissible material that is transparent to microwave radiation.

7. The egg poacher as claimed in claim 1, wherein an upper support member supports the egg cup from an upper portion of the base member, the upper support member being a removable tray overlying the base member.

8. The egg poacher as claimed in claim 7, wherein the upper support member is a tray that is constructed from a microwave transmissible material that is transparent to microwave radiation.

9. An egg poacher for the poaching of one or more eggs in a microwave oven, the egg poacher including:
a base member for holding water;
a tray which is adapted to be removably associated with the base member, the tray having at least one aperture extending therethrough;
one or more cups for eggs, each cup adapted to be removably located in one of an aperture provided in the tray; and
a lid, adapted in use to overlay the base and associated tray, the lid being of a shape such as to provide a gap between an upper surface of the tray and a lower surface of said lid,
the tray spacing the egg cup from an adjacent side of the base member so as to provide a minimum gap between a side of the egg cup and the adjacent side of the base member, wherein the minimum gap extends around the entire horizontal periphery of the egg cup and is measured at a height of the egg cup that is approximate to the height of a raw egg placed in the egg cup with water on top, to thereby entirely shield the raw egg with water.

10. The egg poacher as claimed in claim 9, wherein the egg cup is provided with insignia indicating a level to which the egg cup is recommended to be filled with water after the raw egg is placed in the egg cup.

11. The egg poacher as claimed in claim 9, wherein the base member is provided with insignia indicating the level to which the base member is recommended to be filled with water.

12. The egg poacher as claimed in claim 9, wherein the base member includes a bottom and a peripheral sidewall extending upwardly therefrom, the peripheral sidewall terminating, at the upper end thereof, in a peripheral lip depending outwardly and downwardly therefrom.

13. The egg poacher as claimed in claim 12, wherein the free end of said peripheral lip includes a flange extending therefrom and substantially normally/laterally thereof.

14. The egg poacher as claimed in claim 9, wherein the tray includes a plurality of further smaller apertures extending therethrough, to allow for egress of steam.

15. The egg poacher as claimed in claim 9, wherein the lid includes a plurality of apertures therethrough, to allow for egress of steam.

16. The egg poacher as claimed in claim 9, wherein the egg cup is in the form of a cup-like member including a base or main body portion, closed at one end, and a substantially conical portion extending from the upper end of said base or main body portion.

17. The egg poacher as claimed in claim 16, wherein the base or main body portion has a height of between 25 mm and 40 mm, and preferably between 30 mm and 40 mm, which also corresponds to the recommended depth of the raw egg/water mixture.

18. A method of poaching an egg including:
filling a base member with water;
locating a raw egg in an egg cup that is removably supported by an upper portion of the base member so that the egg cup submerges in the water in the base member, wherein the egg cup is configured to be spaced from an adjacent side of the base member so as to provide a minimum gap between a side of the egg cup and an adjacent side of the base member, wherein the minimum gap extends around the horizontal periphery of the egg cup and is measured at a height of the egg cup that is approximate to the height of a raw egg in the egg cup, and at the gap, surrounding the egg cup with water;
placing water in the egg cup on top of the egg; and
radiating the base, egg cup and egg/water with microwaves in a microwave oven.

19. The method claimed in claim 18, including overlaying a lid over the base and egg cups.
